(19) United States
(12) Patent Application Publication
(10) Pub. No.: US 2002/0110236 A1
(43) Pub. Date: Aug. 15, 2002

(54) Switched mode current feed methods for telephony subscriber loops

(76) Inventor: Ravindra Karnad, Bangalore (IN)

Correspondence Address: TEXAS INSTRUMENTS INCORPORATED, P O BOX 655474, M/S 3999, DALLAS, TX, 75265

(21) Appl. No.: 10/016,778

(22) Filed: Dec. 10, 2001

Related U.S. Application Data
(60) Provisional application No. 60/254,779, filed on Dec. 11, 2000.

(51) Int. Cl. H04M 1/00; H04M 9/00

(52) U.S. Cl. 379/399.01

(57) ABSTRACT

A subscriber loop interface circuit employs a high efficiency constant DC current source implemented using either a switched-mode current boost converter or a switched-mode voltage-to-current trans-converter. The constant DC current source provides higher efficiencies than that achievable using constant voltage sources while presenting a high impedance to voice band signals.

### BACKGROUND OF THE INVENTION

1. Field of the Invention

This invention relates generally to telephony subscriber loops, and more particularly to a switched mode current feed technique to implement a subscriber line interface circuit (SLIC).

2. Description of the Prior Art

The subscriber line interface circuit (SLIC) is being used in the central off (CO) as well as the PBX environment to interface standard telephones, fax equipment, modems, answering machines, and the like. With the advent of voice-over Internet Protocol (VoIP), cable modems (CM) now offer voice telephone services and the SLIC is now resident in the subscriber's premises itself. The evolving standard recommends four telephony connections (i.e. 4 SLICs) in every cable modem.

On of the most important functions of the SLIC, whether in the CO or the CM or any other VoIP environment (like voice over DSL) is “Battery feed” which is nothing but feeding DC power over the telephone cable to the legacy telephone devices. There have been many methods of doing this in the CO environment. Unlike the CO, however, in the CM environment, power consumption is a key factor to consider since the cable must feed power to all the devices (e.g., RF tuner, DSP, analog front-end, etc.) within the CM. It is estimated that infrastructure cost is about $20 for every 1 Watt of power that is to be delivered. Present day SLICs, if used as such, could consume as much as 4×2.5 W=10 W (for all lines active). The better ones consume 4×0.8 W=3.2 W. While the cost of SLICs is in the range of 4×$4=$16, the cost of the power infrastructure will be an enormous 3.2×$20=$64, as depicted in FIG. 1. This cost will eventually have to absorbed by the consumer in terms of higher monthly usage charges.

Importantly, the SLIC dominates the consumption of power in the cable modem. Further, the SLIC has never been viewed with the intention of reducing power, since they have traditionally been deployed in the CO and PBX environments. In these environments, the total power consumption is not dominated by the SLIC power. In the CM environment, however, the situation is very much different, as can be seen from FIG. 2. FIG. 2 illustrates that the SLIC is the single largest power consumer in a cable modem. The data presented herein above demonstrates that every 100 mW of power saved translates into a saving of $2 in power cost.

In view of the foregoing, a need exists for a low power SLIC in order to bring down costs associated with the cable modem.

### SUMMARY OF THE INVENTION

To meet the above and other objectives, the present invention is directed to a low power SLIC that is particularly useful in bringing down costs associated with cable modems used to implement voice telephony services. In the subscriber loop, the loop current has a DC as well as an AC component. The DC component (DC loop current) performs the function of delivering power to the telephone. The AC component is the speech signal. The power levels however, are vastly different: The DC power is a few hundred milliwatts, whereas the AC power is just a few milliwatts. It is the DC current feed then, which must be made efficient if one intends to make power feed efficient. At the same time, such an implementation must not disturb the performance of the AC voice band signals. One embodiment of the low power SLIC is implemented by having two current sources in parallel (one high efficiency, the other high fidelity) as illustrated by FIG. 10. The DC current source has high efficiency and a high impedance in the voice band, while the AC current source synthesizes a 600 Ohm (typical) termination and does the high fidelity speech transmit and receiving (hybrid) functions. The DC current source then is optimized for efficiency while the AC current source is optimized for fidelity (voice band performance). The DC current source is implemented using switched-mode techniques.

In one aspect of the invention, a subscriber line interface circuit is implemented using a switched-mode technique to provide a constant current source having high efficiency and that presents a high-impedance to the voice band signals.

According to one embodiment, a subscriber line interface circuit is implemented using the “DUAL” of a voltage boost converter to provide a current boost converter constant current source having high efficiency and that present a high-impedance to the voice band signals.

According to yet another embodiment, a subscriber line interface circuit is implemented using the “DUAL” of a switched-mode current-to-voltage trans-converter to provide a switched-mode voltage-to-current trans-converter constant current source having high efficiency and that presents a high-impedance to the voice band signals.

### BRIEF DESCRIPTION OF THE DRAWINGS

Other aspects and features of the present invention and many of the attendant advantages of the present invention will be readily appreciated as the same become better understood by reference to the following detailed description when considered in connection with the accompanying drawings in which like reference numerals designate like parts throughout the figures thereof and wherein:

FIG. 1 is a diagram illustrating subscriber line interface circuit costs in a cable modem;

FIG. 2 is a diagram illustrating subscriber line interface circuit power consumption in a cable modem;

FIG. 3 is a diagram illustrating a rough approximation of EIA-470 standard limits associated with telephone characteristics;

FIG. 4 is a diagram illustrating Bellcore TA909 limits for voltage-current characteristics;

FIG. 5 is a diagram illustrating off-hook constant current battery feed characteristics associated with a subscriber line interface circuit;

FIG. 6 is a simplified schematic diagram illustrating a current feed associated with a subscriber line interface circuit;

FIG. 7 is a diagram illustrating SLIC power dissipation for different loop lengths;

FIG. 8 is a diagram illustrating efficiency of power feed associated with a subscriber line interface circuit for different loop lengths and loop currents;

FIG. 9 is a diagram illustrating the power advantage in using the DC-DC converter approach versus a conventional battery feed for a subscriber line interface circuit;

FIG. 10 is a simplified diagram illustrating a DC current source in parallel with an AC current source associated with a subscriber line interface circuit according to one embodiment of the present invention;

FIG. 11 is a simplified schematic diagram illustrating a voltage buck converter that is known in the prior art;

FIG. 12 is a simplified schematic diagram illustrating a voltage boost converter that is known in the prior art;

FIG. 13 is a simplified schematic diagram illustrating a voltage buck-boost converter that is known in the prior art;

FIG. 14 is a simplified schematic diagram illustrating a voltage boost converter and its dual current boost converter;

FIG. 15 is a simplified schematic diagram illustrating two states of the current boost converter depicted in FIG. 14;

FIG. 16 is a diagram illustrating capacitor current and voltage waveforms for the current boost converter depicted in FIG. 14;

FIG. 17 is a schematic diagram illustrating a current boost converter according to one embodiment of the present invention;

FIG. 18 is a simplified schematic diagram illustrating simple L-C filter implemented to reduce voltage fluctuations across a load;

FIG. 19 is a simplified schematic diagram illustrating a switched-mode current-to-voltage trans-converter circuit;

FIG. 20 is a schematic diagram illustrating the two states (charge/discharge) of the switched-mode current-to-voltage trans-converter circuit depicted in FIG. 19;

FIG. 21 is a schematic diagram illustrating the Norton and Thevenin equivalent circuits of the switched-mode current-to-voltage trans-converter circuit depicted in FIG. 19 for its charging stage;

FIG. 22 is a diagram illustrating capacitor charging/discharging waveforms and ripple for the switched-mode current-to-voltage trans-converter circuit depicted in FIG. 19;

FIG. 23 is a schematic diagram illustrating a switched-mode current-to-voltage trans-converter circuit according to one embodiment of the present invention;

FIG. 24 is a schematic diagram illustrating a simple L-C filter implemented to reduce current fluctuations across a load;

FIG. 25 is a simplified schematic diagram illustrating a switched-mode voltage-to-current trans-converter;

FIG. 26 is a diagram illustrating the two states (charge/discharge) of the switched-mode voltage-to-current trans-converter depicted in FIG. 25;

FIG. 27 is a simplified schematic diagram illustrating charging of the inductor by the voltage source for the switched-mode voltage-to-current trans-converter depicted in FIG. 25;

FIG. 28 is a diagram illustrating an inductor charging waveform associated with the switched-mode voltage-to-current trans-converter depicted in FIG. 25;

FIG. 29 is a schematic diagram illustrating a switched-mode voltage-to-current trans-converter according to one embodiment of the present invention;

FIG. 30 illustrates an output current waveform associated with the switched-mode voltage-to-current trans-converter depicted in FIG. 29; and

FIG. 31 is a waveform diagram illustrating output current ripple for the switched-mode voltage-to-current trans-converter depicted in FIG. 29.

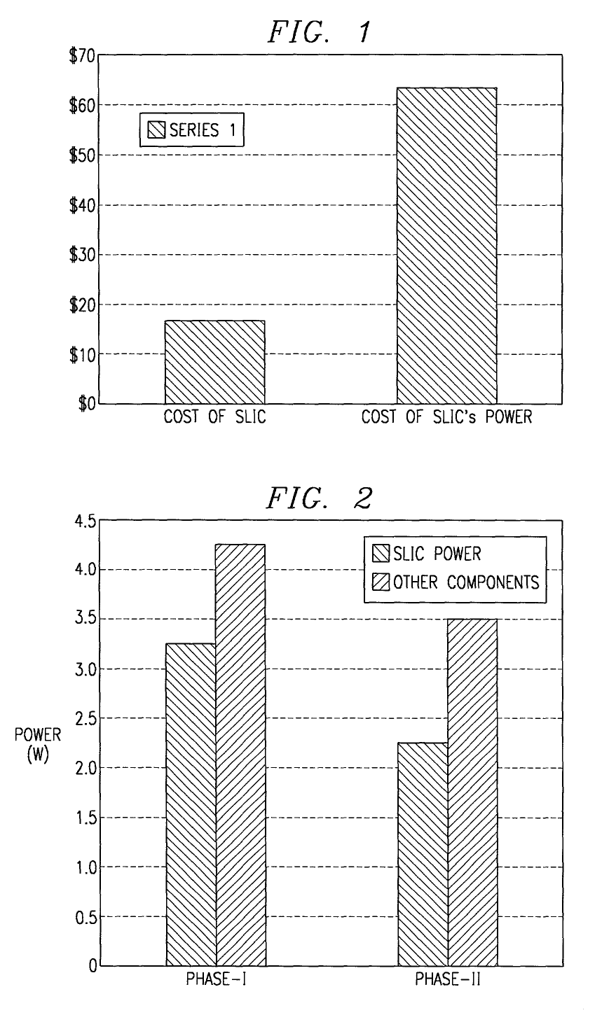

While the above-identified drawing figures set forth particular embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION OF THE PREFERRED EMBODIMENTS

The present invention is best understood by first providing a detailed discussion regarding DC power requirements of the telephone, efficiency of power feed from a subscriber line interface circuit, and the cost of wasted power associated with a particular subscriber loop. DC power requirements are considered first as set forth herein below.

DC Power Requirements of the Telephone

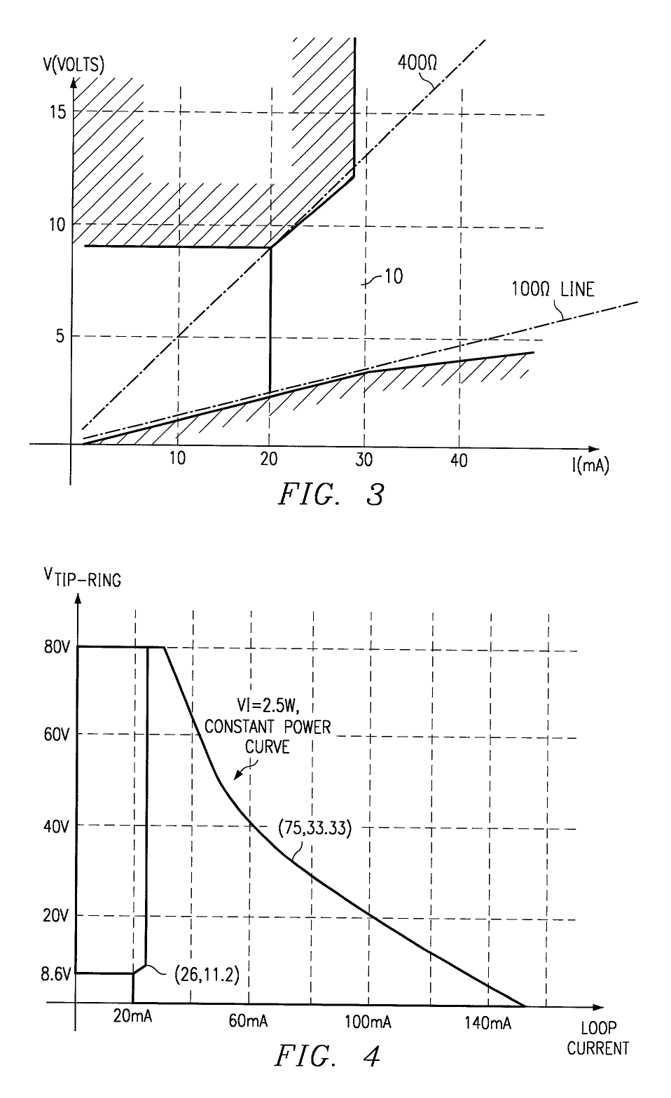

One of the primary functions of the SLIC is to feed DC power to the legacy telephone instruments. Decades ago, the early generation telephones used the loop current (typically 30 mA or more) to power the carbon microphones. Present day speech circuit IC's require much less current and 20 mA is considered more than sufficient for satisfactory operation of electronic phones. The DC V-I characteristics of phones are non-linear, but are expected to meet the characteristics of the EIA-470 standard, which is graphically shown in FIG. 3 (only for currents below 40 mA). Important issues related to this standard include: 1) performance of telephones is not guaranteed for currents below 20 mA; 2) 400 Ohms is the maximum resistance that a phone can have in the range of 20 mA to 30 mA; and 3) 100 Ohms is the minimum resistance that a phone can have in the range of 20 mA to 30 mA. For purposes of loop current estimation and design of battery feed arrangements therefore, it is assumed that phones have a resistance of between 100 Ohms and 400 Ohms in the current range of 20 mA to 30 mA.

The SLIC must now power up the phone to make it operate in this trapezoidal region 10. This can be done either with a voltage source or a current source. Either way, the V-I characteristics of the source must fall within the Bellcore limits shown in FIG. 4. A current source is preferred because of its inherent short-circuit protection (the value of current being between 20 mA and 30 mA). In the case of a cable modem, a loop current of 20 mA can be chosen. In this case, operation of the telephone is restricted to the vertical line at 20 mA between the 100 Ohm and 400 Ohm resistance lines shown in FIG. 3. Power consumption, among other things, can now be examined for this limited region of operation.

Efficiency of Power Feed from SLIC

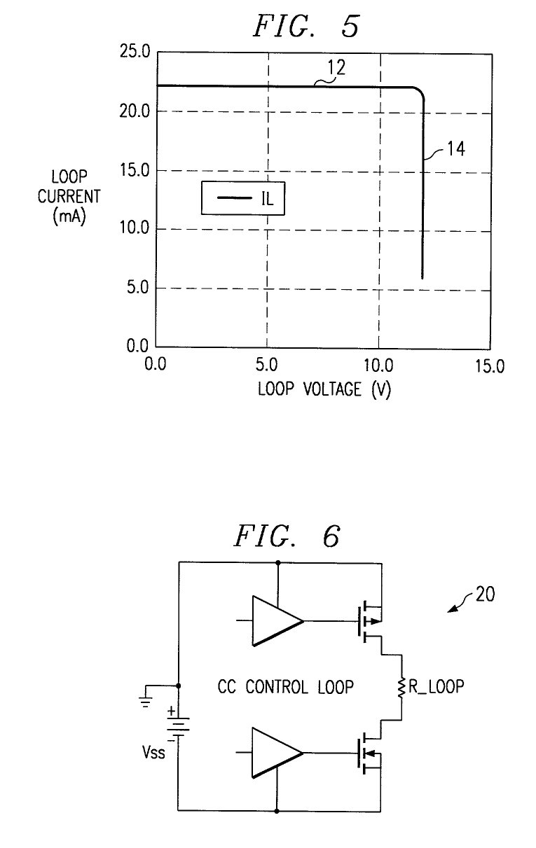

FIG. 5 is a diagram illustrating off-hook constant current (CC) battery feed V-I characteristics associated with a subscriber line interface circuit subject to the conditions set forth herein before. This characteristic can be seen to have two distinct regions: the constant current (CC) region 12, and the voltage limiting (VL) region 14 (where the current drops). If the source has such a characteristic and the telephone has the characteristics shown in FIGS. 3 and 4, the phone by itself, when connected to such a source will get biased in the CC region. When a resistance (representing the line/loop resistance) is placed in series however, then the operating point could well be in the VL region 14, depending on the value of resistance. The longer the loop, the larger the loop voltage, and hence as the line resistance increases, the operating point moves from the CC region 12 towards the right to the VL region 14. The source is designed to operate in the CC region 12 for all values of loop length that is to be served. In the case of the cable modem, the maximum value of line resistance is about 16 Ohms (corresponding to the maximum loop length of 150 meters or 500 feet of AWG 22 wire). Adding to this the following:

1) maximum telephone resistance of 400 Ohms; 2) the standard IEEE home wiring resistance of 30 Ohms; and 3) a protection resistance of 100 Ohms, one gets a total of 546 Ohms. Based upon this value, the SLIC is designed to cater to a loop resistance of 550 Ohms. Since the phone resistance can vary from 100 Ohms to 400 Ohms, the actual loop resistance can vary from almost 200 Ohms to 550 Ohms. Over this range of loop resistance, the battery feed source will remain in the CC region. The power consumption pattern and efficiency of the SLICs can be examined by looking at a simple current feed circuit model 20 illustrated in FIG. 6 that will be applicable for most CCVL implementations. The power dissipated in the circuit 20 is dependent on: 1) supply voltage; 2) loop resistance; and 3) constant current value of loop current. The power dissipated in the circuit 20 during the off-hook constant current feed is estimated by the following equation:

P_{D}=1.1I_{L}V_{SS}−I_{L}²R_{L} (1)

Equation (1) can be rewritten as:

P_{D}=P_{CON}−P_{LOOP} (2)

where I_{L} is the loop current, R_{L} is the loop resistance (telephone plus cable, wiring and protection resistances), P_{CON} is the power consumed from the supply voltage V_{SS} and 1.1I_{L}V_{SS}, and P_{LOOP} is the power delivered to the loop (i.e. the telephone and cable together) and=I_{L}²R_{L}. The factor of 1.1 is incorporated within P_{CON} to account for bias currents and other miscellaneous current drains. The value of V_{SS} is estimated as follows:

V_{SS}=(I_{L}R_{L(max)}+2V_{DS(min)}+Δ), (3)

where Δ is the swing required for the largest speech signal on the line. This estimate of V_{SS} is based on serving the largest value of R_{L}. Interestingly, for a given value of I_{L} and V_{SS}, the power P_{D} dissipated in the circuit 20 depends upon the loop current I_{L} and the loop resistance R_{L}. With short loops, (small values of R_{L}) more power is dissipated in the circuit 20 and less in the loop. With long loops, (larger values of R_{L}) the loop power increases and the power dissipated in the circuit 20 decreases. The total power drawn from the battery (P_{CON}) remains constant and will not vary with loop resistance (R_{L}) since it depends only on I_{L} and V_{SS}.

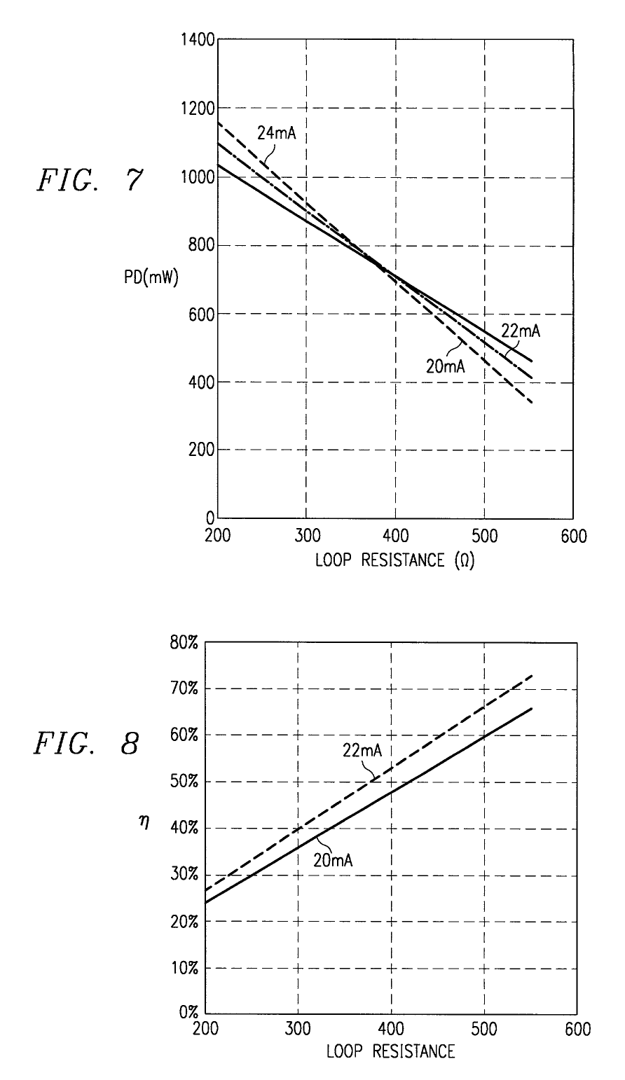

Equation (1), which is indicative of the dissipated power, and its variation with loop length for different loop currents is shown in FIG. 7 (after multiplying by 4, for 4 lines being off-hook). This plot shows that at certain values of R_{L}, the power P_{D} dissipated in the circuit 20 for 20 mA current is actually higher than that for 24 mA. This is, of course, due to the fact that the dissipated power P_{D} drops off at the rate of I_{L}². The implication of this is that the battery feed can actually be more efficient at higher values of loop current at certain loop lengths. The foregoing equations can be used to estimate the efficiency of power feed and to demonstrate that the conventional method is grossly inefficient, as can be seen with reference to FIG. 8, which shows that for a large range of loop resistances, the efficiency is actually below 50%.

The Cost of Wasted Power

Minimization of power consumption can be illustrated by choosing the lowest possible value of current, i.e. 20 mA. Clearly, at this chosen loop current, the efficiency η is very poor (56% at 400 Ohms, 44% at 300 Ohms, and just 31% at 200 Ohms). A low-power phone drops a small voltage and would present a lower resistance (say 300 Ohms or 200 Ohms) to the loop and will therefore consume less power. Although the phone consumes less power however, the power consumed by the SLIC remains the same. This is because the power not utilized by the phone is dissipated by the SLIC.

In order to benefit from the reduced power consumption of the loop (phone or any other component such as lower wiring resistance, etc.), a constant efficiency battery feed mechanism is required. This essentially means that is less power is to be delivered, then less power is actually consumed. This property is inherent in DC-DC converters or switched-mode power conversion. The benefits of such a power feed method can be examined by assuming that one can achieve, for example, a constant efficiency η of about 85%. Many DC-DC converters such as the model TPS5102 commercially available from Texas Instruments Incorporated of Dallas, Tex., can achieve however, efficiencies of more than 90%. The cost benefits are shown in Table 1 below that illustrates savings in power and cost by using a DC-DC converter to implement a constant efficiency batter feed mechanism.

TABLE 1
Savings in power and cost by using a DC-DC converter

| Cost of wasted power | | | | | |
|---|---|---|---|---|---|
| RL | Ploop | Pcon | Pcon (DC-DC) | Psaved | $ Saved |
| 200 | 320 | 1232 | 376 | 856 | 17.11 |
| 225 | 360 | 1232 | 424 | 808 | 16.17 |
| 250 | 400 | 1232 | 471 | 761 | 15.23 |
| 275 | 440 | 1232 | 518 | 714 | 14.29 |
| 300 | 480 | 1232 | 565 | 667 | 13.35 |
| 325 | 520 | 1232 | 612 | 620 | 12.40 |
| 350 | 560 | 1232 | 659 | 573 | 11.46 |
| 375 | 600 | 1232 | 706 | 526 | 10.52 |
| 400 | 640 | 1232 | 753 | 479 | 9.58 |
| 425 | 680 | 1232 | 800 | 432 | 8.64 |
| 450 | 720 | 1232 | 847 | 385 | 7.70 |
| 475 | 760 | 1232 | 894 | 338 | 6.76 |
| 500 | 800 | 1232 | 941 | 291 | 5.82 |
| 525 | 840 | 1232 | 988 | 244 | 4.88 |
| 550 | 880 | 1232 | 1035 | 197 | 3.93 |

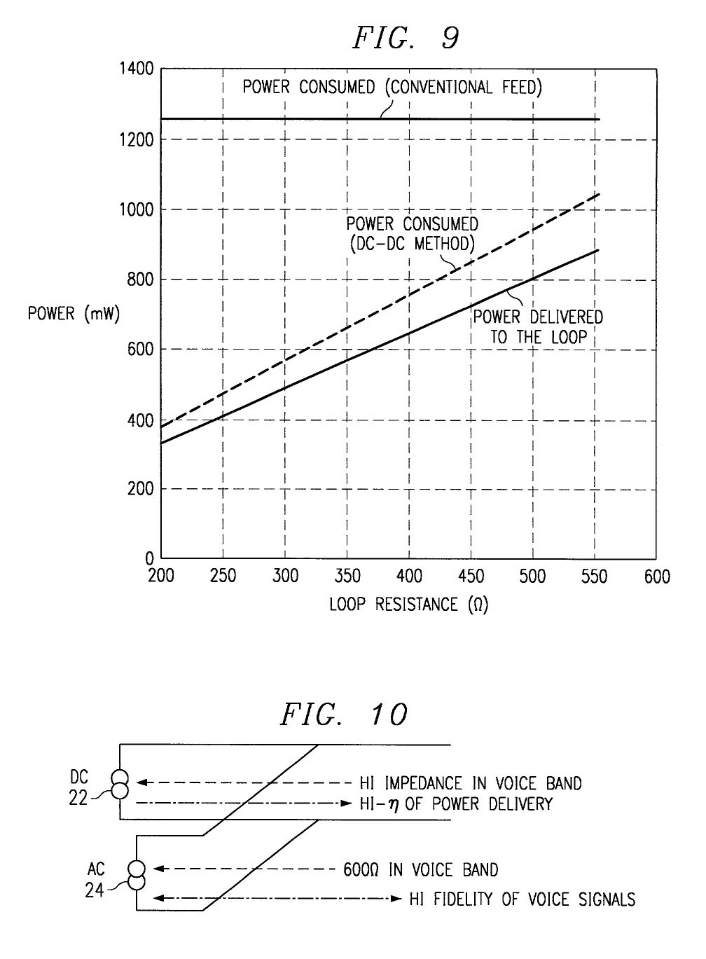

The power levels depicted in Table 1 above can be seen plotted in FIG. 9 in which it becomes apparent that the advantage gained is dependent on the loop length. In any case, the DC-DC converter method is always more efficient.

In the subscriber loop, as stated herein before, the loop current has a DC as well as an AC component. The DC component (DC loop current) performs the function of delivering power to the telephone. The AC component is the speech signal. The power levels however, are vastly different. The DC power is a few hundred milliwatts whereas the AC power is just a few milliwatts. Hence, if one intends to make power feed efficient, then it is the DC current feed which must be made efficient. At the same time, such an implementation must not disturb the performance of the AC voice band signals. This can be achieved by having two current sources in parallel as shown in FIG. 10, wherein the DC current source 22 preferably has high efficiency (η) between 85% and 90% as well as a high impedance in the voice band. The AC current source 24 synthesizes a 600 Ohm (typical) termination and accommodates the high fidelity speech transmit and receive functions (hybrid functions). The DC current source 22 is then optimized for efficiency while the AC current source 24 is optimized for fidelity (voice band performance). In view of the foregoing, the DC current source 22 is most preferably implemented using switched-mode techniques.

The basic structures of switched-mode converters disclosed in the literature are directed to voltage converters including 1) BUCK, illustrated in FIG. 11, where the output voltage is always less than the input voltage; 2) BOOST, illustrated in FIG. 12, where the output voltage is always greater than the input voltage; and 3) BUCK-BOOST, illustrated in FIG. 13, where the output voltage can be less than or greater than the input voltage. None of these basic circuit topologies is suitable for implementing the desired constant DC current source for two reasons: First, they are constant voltage sources, and second (and more important), they all have a large capacitor at the output which will present a low impedance to voice band signals. Two switched-mode schemes including the dual of the voltage BOOST converter and the switched-mode voltage-to-current trans-converter, can however, be implemented to achieve the desired high efficiency while presenting a high impedance to the voice band signals.

The dual of the voltage BOOST converter can be arrived at by converting one of the basic topologies depicted in FIGS. 11-13 into its respective “DUAL.” The “DUAL” of a circuit topology is like a “mirror image”, and is generally arrived at by: 1) replacing an inductor by a capacitor and vice-versa; and 2) replacing a current source by a voltage source and vice-versa; and 3) replacing a series element by the dual of the same element in shunt; and 4) replacing a shunt element by the dual of the same element in series; and 5) replacing a closed switch by an open switch and vice-versa. Once these transformations are complete, it will be found that the current equations (or waveforms) of the dual are like the voltage equations (or waveforms) or the original. This can be exemplified with reference now to FIG. 14 that depicts a voltage boost converter 30 and its dual (current boost converter) 32 that is obtained by applying the rules of duality set forth above. It can be seen that since there is a series inductor 34 at the output, there is a possibility of achieving a high impedance in the voice band. (This is achieved not simply by virtue of the impedance of the inductor, but also by the feedback that maintains a constant current.)

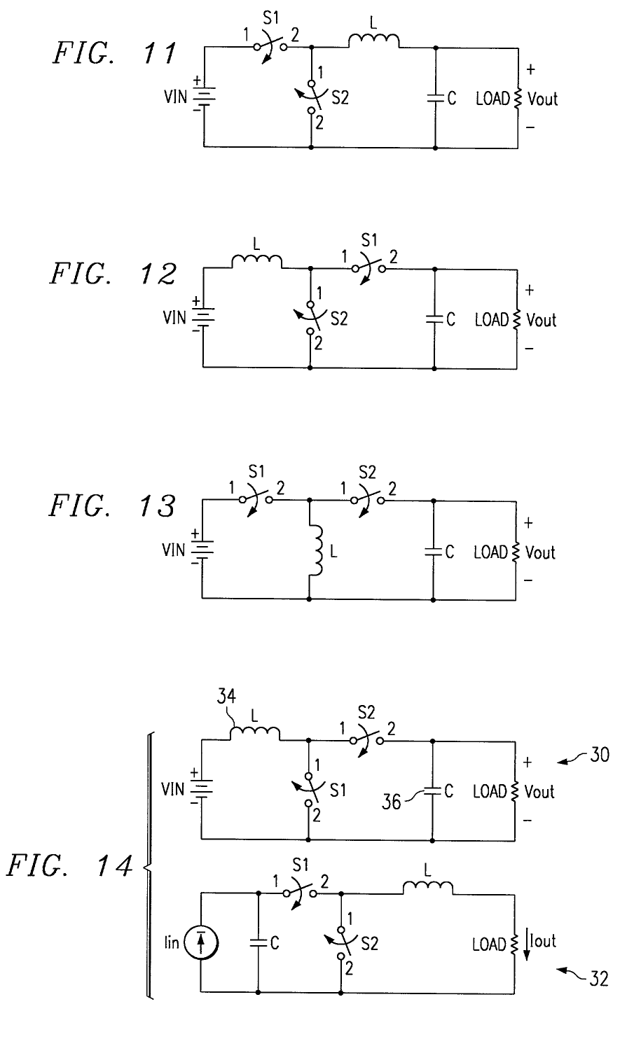

A first order analysis of converter 30 can be implemented, for example, by assuming 1) in the steady-state, there is no net build-up or no net loss of energy in the inductor 34 and the capacitor 36; and 2) the inductor 34 is large enough to have a very low (˜1%) current ripple. The converter 30 has two distinct states including State-1 in which switch S1 is open and switch S2 is closed, and State-2 in which switch S1 is closed and switch S2 is open. The equivalent circuits corresponding to these two states are depicted in FIG. 15. The analysis also assumes the duty cycle of the switching is δ and the time period is T_{P}. State-1 therefore, lasts for δT_{P} seconds and State-2 lasts for (1−δ) T_{P} seconds. In State-1, the capacitor 36 is being charged by the input current and the voltage build-up is given by:

C*ΔV_{C1}=I_{IN}*δT_{P}, (4)

which can be rewritten as

ΔV_{C1}=(I_{IN}*δT_{P})/C (5)

Since ΔV_{C1} is positive, the capacitor 36 energy increases. In State-2, because of the steady-state assumption, the capacitor 36 energy therefore must decrease. ΔV_{C2} must therefore be negative. This means that the net current must flow out of the capacitor 36, and the voltage discharge is given by:

C*ΔV_{C2}=(I_{IN}−I_{OUT})*(1−δ)T_{P} (6)

since ΔV_{C2}<0.

I_{OUT} therefore is greater than I_{IN}, which proves the BOOST operation of the current source. Moreover, the magnitude of ΔV_{C1} is equal to the magnitude of ΔV_{C2}, which means

(I_{IN}*δT_{P})=(I_{OUT}−I_{IN})*(1−δ)T_{P} (7)

which can be rewritten as

δI_{IN}=I_{OUT}(1−δ)−I_{IN}+δI_{IN}, (8)

and therefore

I_{OUT}=I_{IN}/(1−δ) (9)

The waveforms of the current boost converter (CBC) are very similar to the waveforms generated by the voltage boost converter (VBC) in that the capacitor voltage waveform in the CBC is like the inductor current waveform in the VBC. Further, the inductor current in the VBC has equal +Ve and −Ve areas, while the capacitor voltage in the CBC has equal +Ve and −Ve areas. Capacitor current and voltage waveforms for the current boost converter are shown in FIG. 16 for a δ=0.33 or a boost ratio of 1.5.

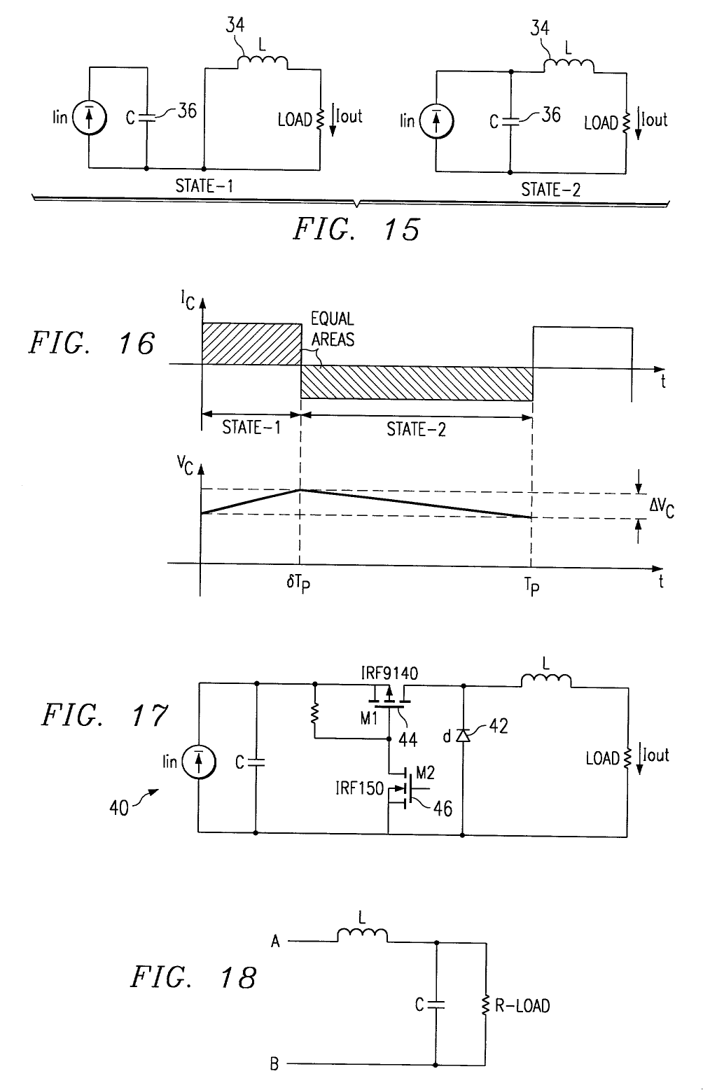

One preferred embodiment of a current boost circuit 40 is shown in FIG. 17. In voltage converters, one of the switches is usually a diode so as to simplify the control. Switch S2 then, is simply a fast recovery diode 42 that will turn off whenever switch S1 (transistor M1) 44 is turned on. The percentage of time for which the converter 40 is in State-1 is designated δ, as stated herein before. This is the state in which S1 (transistor M1) 44 is off. The transistor M2 (46) is used to control transistor M1 (44). The driving signal for transistor M2 (46) should therefore have a duty cycle of (1−δ). It can be appreciated that the δ has to be dynamically varied to keep the output current constant. This is easily achieved by using any industry standard PWM controller such as the TPS5102 or the TPS6734 commercially available from Texas Instruments Incorporated of Dallas, Tex.

The current boost converter shown in FIG. 17 discussed herein above is efficient provided there is a current source available. The primary power source however, is almost always a voltage source and not a current source. In these instances, the input current source needs to be constructed from a voltage source. This is generally done with a linear element such as an op-amp or a transistor (operating in its linear region). The overall efficiency of a system using such a scheme will be the product of the efficiencies of the voltage-to-current converter (linear) and the current-to-current converter (switched-mode); and since the individual efficiencies are always less than 100%, the resultant efficiency will be less than the lower of the two efficiencies. If the basic current source, for example, has a η1=50% (which is good for a linear block), and the switched-mode current source has a η2=90%, then ηoverall=0.5×0.9=0.45 or 45%. There then must be an efficient method of converting voltage to current to overcome this system deficiency. One preferred embodiment for converting voltage to current employs a switched-mode voltage-to-current trans-converter. Operating principles of the switched-mode voltage-to-current trans-converter can be understood by first exploring the operating principles of a switched-mode current-to-voltage trans-converter. This trans-conversion is implemented by exploiting the well-known basic properties of the capacitor and the inductor as circuit elements in which

$$V = L \frac{ⅆ I}{ⅆ t} and I = C \frac{ⅆ V}{ⅆ t} .$$

Using these basic relationships, one can derive a voltage source from a current source and vice-versa, using only switched-mode techniques. This approach will ensure that a minimum of power is lost and that η is maximized.

Current-to-voltage trans-conversion is first explored by assuming the relationship

$$I = C \frac{ⅆ V}{ⅆ t} or Vc ( t ) = \frac{1}{C} {\int }_{0}^{t} i ( {t}^{*} ) ⅆ {t}^{*}$$

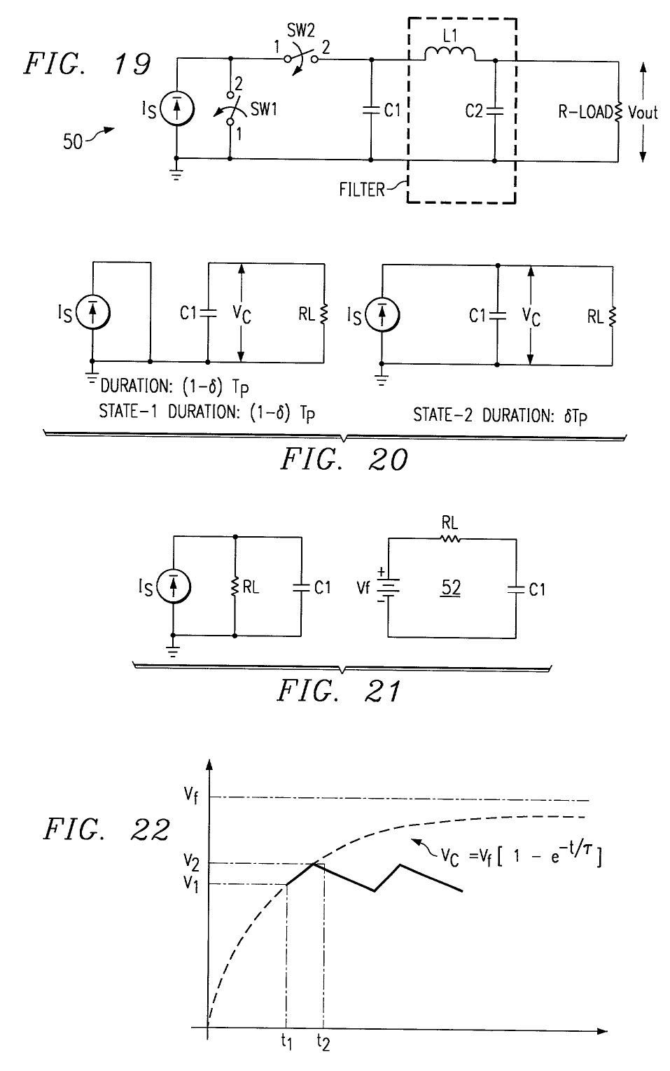

is used to convert current into voltage by accumulating (or integrating) the current flowing into a capacitor. The load needs a constant voltage, and hence, one can insert an LC filter such as shown in FIG. 18, before the load to smoothen out any voltage fluctuations. A fluctuating voltage applied across points “A” and “B” in FIG. 18 will therefore appear filtered across R_{LOAD}. If a current source is periodically switched onto a capacitor to create a fluctuating voltage, it can then be filtered using an LC filter such as depicted in FIG. 18. One such filtered current source is shown in FIG. 19 that illustrates a simplified switched-mode current-to-voltage trans-converter 50. Here, a capacitor C1 has been placed along with two switches, SW1 and SW2, to integrate the current and convert it into a fluctuating voltage that is later filtered by the filter of FIG. 18 (formed by L1 and C2). It can be appreciated that the capacitor C1 is used to perform the actual current-to-voltage conversion while the capacitor C2 is part of the LC filter. The trans-converter 50 operates the switches, SW1 and SW2, alternately and in complimentary fashion (i.e. when one is on, the other is off). This can be represented as two states as shown in FIG. 20. There is a build-up of voltage on the capacitor C1 in State-2, and a decrease in voltage on the capacitor C1 in State-1. The duty cycle can be so adjusted (i.e. using an error amplifier and a PWM controller familiar to those skilled in the art) such that the voltage on the load remains constant regardless of the value of R_{LOAD}.

Analysis of the switched-mode trans-converter 50 is better understood by recognizing the function of the LC filter is merely to filter out the voltage ripple on the capacitor and that it does not play any role in the current-to-voltage conversion. This is ensured by making the cut-off frequency of the LC filter much smaller than the switching frequency. Thus, to analyze the trans-converter 50, it is convenient to ignore the LC filter. In State-1, the capacitor C1 supplies the load current. This causes the voltage on it to droop by an amount ΔV_{C}. In State-2, the capacitor C1 charges up by the same amount (assuming a steady-state condition where there is neither a net increase nor a net decrease of energy). Since the voltage on a capacitor represents a stored energy, the change in voltage by an amount ΔV_{C} also represents a change in energy ΔE_{C}. When considering a capacitor that is charging from a voltage V₁ to a voltage V₂, for example, such that V₂=(V₁+ΔV_{C}), the corresponding change in energy is:

$$Δ Ec = \frac{1}{2} C [ {( {V}_{1} + Δ Vc )}^{2} - {V}_{1}^{2} ] \qquad ( 10 )$$

Assuming further a low-ripple condition where V₁>>ΔV_{C}, the change in energy can be written as:

ΔE_{C}=CV_{O}ΔV_{C}, (11)

where V_{O} is the average output voltage and ≅V₁, V₂. The term ΔE_{C} represents both the increase in energy in State-2 as well as the decrease in energy in State-1. In State-1, for a duration (1−δ)T_{F}, the resistor R_{L} dissipates an energy E_{R}; and this energy has to come from the capacitor C1 since the source has been disconnected. The equation for this energy can be written as:

$${E}_{R} = \frac{{( Vo )}^{2}}{{R}_{L}} ( 1 - δ ) {T}_{P} = Δ Ec = CVo Δ Vc , \qquad ( 12 )$$

and therefore,

V_{O}(1−δ)T_{P}=R_{L}CΔV_{C}. (13)

The voltage ripple ΔV_{C} can be estimated by considering the Thevenin equivalent circuit as shown by FIG. 21, when the capacitor is being charged by the current source I_{S} in State-2. With reference now to the Thevenin equivalent circuit 52 depicted in FIG. 21, the capacitor voltage can be written as:

V_{C}=V_{f}[1−e^{-t/τ}], (14)

where V_{f}=I_{S}R_{L}. An estimate of the ripple ΔV_{C}, or the amount by which the capacitor C1 charges up in the interval δT_{P} can be made by assuming that the capacitor C1 charges from v₁ at t₁ to v₂ at t₂ such as illustrated in FIG. 22. The ripple can then be estimated by recognizing

$$Δ Vc = \frac{ⅆ Vc}{ⅆ t} Δ t ,$$

and since

$$\frac{ⅆ Vc}{ⅆ t} = \frac{{V}_{f}}{τ} {e}^{\frac{- t}{τ}} ,$$

$$Δ Vc = \frac{{V}_{f}}{τ} {e}^{\frac{- t}{τ}} Δ t . \qquad ( 15 )$$

Evaluating equation (15) at t=t₁ and letting Δt=δT_{P}, τ=R_{L}C, V_{f}=I_{S}R_{L}, and V₁=V_{O},

$$Δ Vc = \frac{{I}_{S} {R}_{L}}{{R}_{L} C} [ 1 - \frac{Vo}{{I}_{S} {R}_{L}} ] δ {T}_{P} . \qquad ( 16 )$$

Substituting equation (16) into equation (13), it can be shown that

$$Vo ( 1 - δ ) {T}_{P} = {R}_{L} C \frac{{I}_{S} {R}_{L}}{{R}_{L} C} [ 1 - \frac{Vo}{{I}_{S} {R}_{L}} ] δ {T}_{P} ,$$

which after simplification yields

$$Vo ( 1 - δ ) = {I}_{S} {R}_{L} [ 1 - \frac{Vo}{{I}_{S} {R}_{L}} ] δ ,$$

or

V_{O}=δI_{S}R_{L} (17)

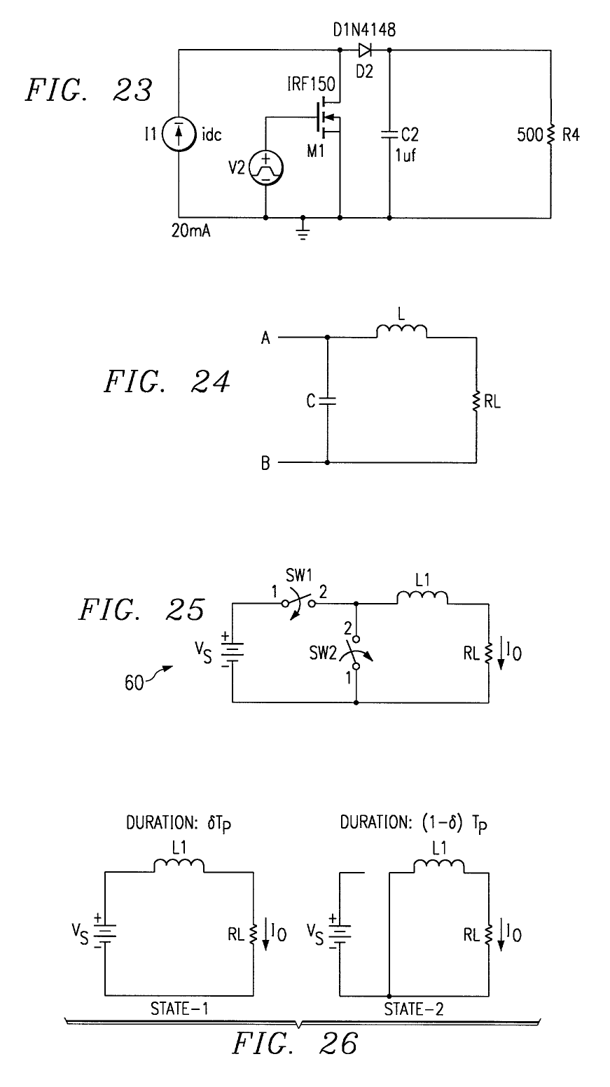

The relation shown by equation (17) can also be seen to be intuitively correct, since if the transconverter was continuously in State-2, i.e. δ=1, then the capacitor C1 would charge to a steady-state voltage of V_{O}=I_{S}R_{L}. It can be appreciated that equation (17) must be corrected slightly due to the finite on voltage of the switches used in an actual application. One such actual application is illustrated in FIG. 23 that depicts implementation of a switched-mode current-to-voltage trans-converter. In this implementation, the switch S1 is implemented by the transistor M1 and the switch S2 is implemented by the diode D2. Whenever the transistor M1 is turned on, the diode D2 will be reverse biased and hence in its off state. When the capacitor C2 is being charged by the current source I₁ (20 mA) however, the diode D2 will have a voltage drop of V_{γ}=0.65 v. The relationship shown by equation (17) can then be modified to also consider the voltage drop such that

V_{O}=δ(I_{S}R_{L}−V_{γ}) (18)

Ripple is another dimensionless quantity that can be defined as a fraction of the output voltage, and can be written as

$${N}_{RIP} = \frac{Δ Vc}{Vo} = \frac{( 1 - δ ) {T}_{P}}{{R}_{L} C} = \frac{( 1 - δ ) {T}_{P}}{{τ}_{RC}} . \qquad ( 19 )$$

As can be (intuitively) seen, the larger the time constant as compared to the time interval of State-1 during which the capacitor voltage begins to droop, the lower the ripple. Performance of the “DUAL” of the trans-converter shown in FIG. 23 is herein below compared with the trans-converter shown in FIG. 23 itself, using the dimensionless ripple quantity discussed above. The present inventor found that equation (18) above closely matched actual circuit simulation results, except in cases where δ is small, since the diode D2 drop would also change. Table 2 illustrates the comparison.

TABLE 2

| δ | Vₒ using Eq (18) | Vₒ from simulation | Error |
|---|---|---|---|
| 0.2 | 1.87 | 1.78 | −5.06% |
| 0.5 | 4.675 | 4.64 | −0.75% |
| 0.7 | 6.55 | 6.57 | 0.30% |
| 0.8 | 7.48 | 7.53 | 0.66% |
| 0.9 | 8.42 | 8.48 | 0.71% |

Since most power sources are voltage sources, and because what is needed on the subscriber loop is a constant current source, it is more useful to have a voltage-to-current trans-converter. Such a trans-converter can be a dual of the current-to-voltage trans-converter that was described herein before with reference to FIGS. 18-23. It can easily be ascertained that because of the “duality” principle, all equations and waveforms are similar to that of the current-to-voltage trans-converter. Analysis of the switched-mode voltage-to-current trans-converter can be accomplished by first considering the relationship

$$V = L \frac{ⅆ I}{ⅆ t} or {i}_{L} ( t ) = \frac{1}{L} {\int }_{0}^{t} v ( {t}^{*} ) ⅆ {t}^{*} ,$$

which is integrating the voltage across an inductor. Just as a capacitor may have a voltage ripple (fluctuating voltage), an inductor may have a current ripple (fluctuating current). This current ripple can be filtered by the dual of the filter shown in FIG. 18, and which is illustrated in FIG. 24. If a fluctuating current source is applied between points “A” and “B” in FIG. 24, the current through the load R_{L} will be filtered. In similar fashion, a basic voltage-to-current trans-converter can be implemented using the dual of the circuit shown in FIG. 19, such as illustrated in FIG. 25 that depicts a switched-mode voltage-to-current trans-converter 60.

The trans-converter 60 shown in FIG. 25 operates the switches SW1 and SW2 alternately and in complimentary fashion (when one is on, the other is off). This can be represented as two states as shown in FIG. 26. There is a build-up of current in the inductor L1 in State-2 and a decrease in the inductor L1 current in State-1. The duty cycle can be adjusted (with an error amplifier and a PWM controller well known in the art) so that the current through the load R_{L} remains constant regardless of the value of R_{L}.

The function of the LC filter shown in FIG. 24 is merely to filter out the current ripple of the inductor; and it does not play any role in the current-to-voltage conversion. This is ensured by making the cut-off frequency of the LC filter much smaller than the switching frequency. The LC filter is therefore not shown in FIG. 26 since it need not be considered in the analysis.

With continued reference now to FIG. 26, the inductor supplies the load current I_{O} in State-2. This causes the current through the inductor to droop by an amount ΔI_{L}. In State-1, the inductor current builds up by the same amount (assuming a steady-state condition where there is neither a net increase nor a net decrease of energy). Since the current through the inductor represents a stored energy, the change in current through the inductor represents a stored energy. A change in the inductor current by an amount ΔI_{L} also then represents a change in energy by an amount ΔE_{L}. This can be exemplified by considering an inductor having a current the builds up from I₁ to a value I₂ such that I₂=(I₁+ΔI_{L}). The corresponding change in energy is then:

$$Δ {E}_{L} = \frac{1}{2} L [ {( {I}_{1} + Δ {I}_{L} )}^{2} - {I}_{1}^{2} ] . \qquad ( 20 )$$

If it is further assumed a low-ripple condition exists, where I₁>>ΔI_{L}, the change in energy can be approximated as

ΔE_{L}=LI_{O}ΔI_{L}, (21)

where I_{O} is the average output current and ≅I₁, I₂. The ΔE_{L} term represents both and increase in energy in State-1 as well as a decrease in energy in State-2. In State-2, for a duration (1−δ)T_{P}, the resistor R_{L} dissipate an energy E_{R} that must be provided by the inductor since the source has been disconnected. It can then be shown that

E_{R}=(I_{O})²R_{L}(1−δ)T_{P}=ΔE_{L}=LI_{O}ΔI_{L}, (22)

which can be modified to show

I_{O}R_{L}(1−δ)T_{P}=LΔI_{L}. (23)

The current ripple ΔI_{L} can be estimated by considering the equivalent circuit illustrated in FIG. 27 that depicts the inductor being charged by a voltage source in State-1. The inductor current can be written as:

$${I}_{L} = {I}_{f} [ 1 - {ⅇ}^{- t / τ} ] , where {I}_{f} = \frac{{V}_{S}}{{R}_{L}} .$$

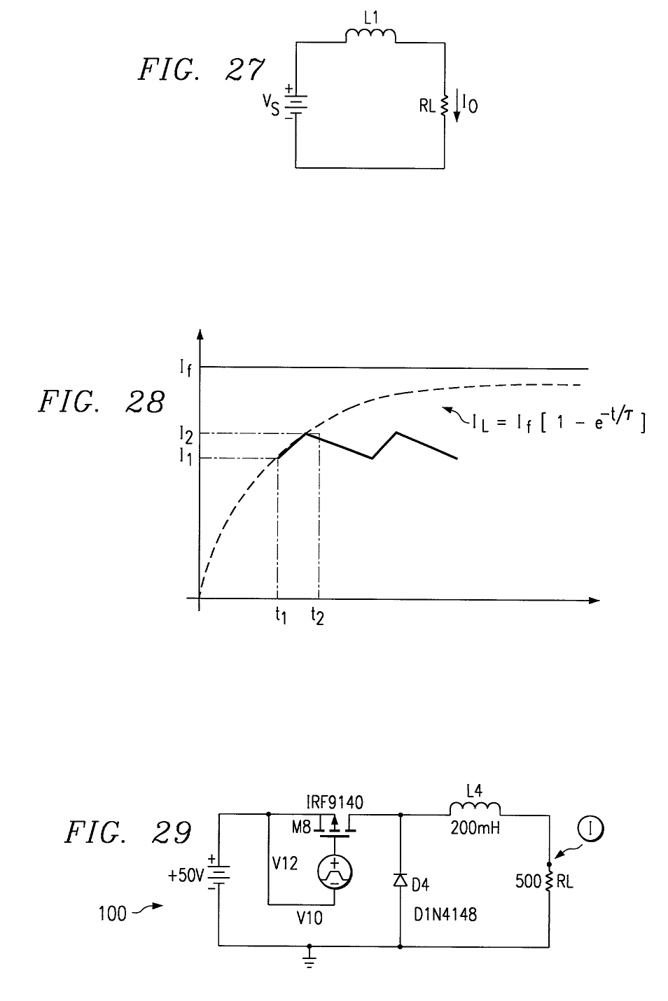

An estimate of the current ripple ΔI_{L} (amount by which the inductor charges up in the interval δT_{P}) can be made by assuming that the inductor charges from current I₁ at time t₁ to current I₂ at time t₂, as shown in FIG. 28 that depicts the inductor current waveform caused by charging of the inductor by the voltage source in State-1. Using the foregoing assumption, the current ripple ΔI_{L} can now be estimated by recognizing that

$$\begin{matrix}Δ {I}_{L} = \frac{ⅆ {I}_{L}}{ⅆ t} Δ t ; and since \\ \frac{ⅆ {I}_{L}}{ⅆ t} = \frac{{I}_{f}}{{τ}_{RL}} {ⅇ}^{- t / τ} , \\ Δ {I}_{L} = \frac{{I}_{f}}{{τ}_{RL}} {ⅇ}^{- t / τ} Δ t .\end{matrix} \qquad ( 24 )$$

Evaluating equation (24) at t=t₁, and letting Δt=δT_{P},

$${τ}_{RL} = \frac{L}{{R}_{L}} , {I}_{f} = \frac{{V}_{S}}{{R}_{L}} ,$$

and I₁=I_{O},

$$Δ {I}_{L} = \frac{{V}_{S}}{L} [ 1 - \frac{{I}_{O} {R}_{L}}{{V}_{S}} ] δ {T}_{P} . \qquad ( 25 )$$

Substituting equation (25) into equation (23) provides

$${I}_{O} {R}_{L} ( 1 - δ ) {T}_{P} = L \frac{{V}_{S}}{L} [ 1 - \frac{{I}_{O} {R}_{L}}{{V}_{S}} ] δ {T}_{P} ,$$

which after simplification, yields:

$${I}_{O} {R}_{L} ( 1 - δ ) = {V}_{S} [ 1 - \frac{{I}_{O} {R}_{L}}{{V}_{S}} ] δ . \qquad ( 26 )$$

Rearranging equation (26) finally yields:

$${I}_{O} = δ \frac{{V}_{S}}{{R}_{L}} . \qquad ( 27 )$$

It can be readily appreciated the relation shown by equation (27) is intuitively correct, since if the circuit shown in FIG. 27 were continuously in State-1, i.e. δ=1, then the inductor would charge to a steady-state current of

$${I}_{O} = {I}_{f} = \frac{{V}_{S}}{{R}_{L}} .$$

The relation specified by equation 27 must be corrected slightly in an actual switched-mode voltage-to-current trans-converter 100 implementation such as illustrated in FIG. 29, due to the finite on voltage of the switches employed. In this case, it is the on voltage of the transistor M8 that will reduce the effective value of V_{S} such that

$$\begin{matrix}{I}_{f} = \frac{{V}_{S} - {V}_{DS ( ON )}}{{R}_{L}} . \\ Hence , & ( 28 ) \\ {I}_{O} = δ [ \frac{{V}_{S} - {V}_{DS ( ON )}}{{R}_{L}} ] , & ( 29 )\end{matrix}$$

The dimensionless quantity N_{RIP}, which is the ripple expressed as a fraction of the output voltage in the instant case, can be expressed as:

$${N}_{RIP} = \frac{{ΔI}_{L}}{{I}_{O}} = \frac{{R}_{L} ( 1 - δ ) {T}_{P}}{L} = \frac{( 1 - δ ) {T}_{P}}{{τ}_{RL}} . \qquad ( 30 )$$

In view of the foregoing, it can be (intuitively) seen, the larger the time constant as compared to the time interval of State-2 during which the inductor current begins to droop, the lower the ripple. Implementing the voltage-to-current trans-converter 100 shown in FIG. 29 produces notable differences over current-to-voltage trans-converter implementation discussed herein before with reference to FIGS. 18-23. Since it is more difficult, for example, to obtain a high value of inductance, it is better to permit a larger value of N_{RIP} and allow the filter to remove the ripple. Further, it may be difficult to get the transistor M8 to turn on/off fast enough with a highly inductive load. It is better in this case therefore, to operate at lower frequencies in order to keep the drive circuit simple. The present inventor found output current results provided by equation (29) to provide nearly identical results from a simulated implementation of the voltage-to-current trans-converter shown in FIG. 29 in cases where δ is small since the condition of _{τRL}>>(1−δ)T_{P} is more difficult to achieve. The comparison is shown in Table 3 below.

TABLE 3

| δ | Io(calculated) | Io(simulated) | Error |
|---|---|---|---|
| 0.1 | 10 | 11.64 | 16.40% |
| 0.2 | 20 | 20.51 | 2.55% |
| 0.3 | 30 | 30.06 | 0.20% |
| 0.4 | 40 | 39.85 | −0.37% |
| 0.5 | 50 | 49.68 | −0.64% |
| 0.6 | 60 | 59.73 | −0.45% |
| 0.8 | 80 | 79.99 | −0.01% |
| 0.9 | 90 | 90.01 | −0.01% |

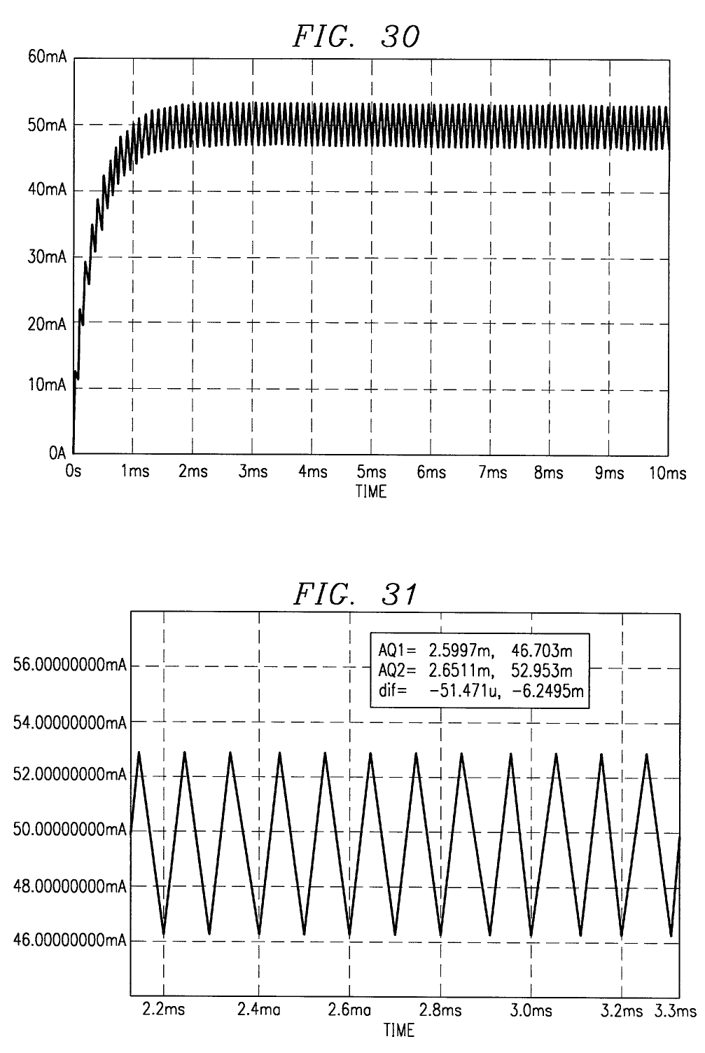

FIG. 30 depicts a current waveform (I_{O}) with δ=0.5 for a simulated implementation of the voltage-to-current trans-converter 100 shown in FIG. 29; while FIG. 31 depicts a current ripple waveform ΔI_{O} with δ=0.5 for the simulated implementation of the voltage-to-current trans-converter 100 shown in FIG. 29.

In view of the above, it can be seen the present invention presents a significant advancement in the art of switched-mode current feed techniques for subscriber loops employed in telephony applications. Further, this invention has been described in considerable detail in order to provide those skilled in the data communication art with the information needed to apply the novel principles and to construct and use such specialized components as are required. In view of the foregoing descriptions, it should further be apparent that the present invention represents a significant departure from the prior art in construction and operation. However, while particular embodiments of the present invention have been described herein in detail, it is to be understood that various alterations, modifications and substitutions can be made therein without departing in any way from the spirit and scope of the present invention, as defined in the claims which follow. For example, although various embodiments have been presented herein with reference to particular transistor types, the present inventive structures and characteristics are not necessarily limited to particular transistor types or sets of characteristics as used herein. It shall be understood the embodiments described herein above can easily be implemented using many diverse transistor types so long as the combinations achieve a low power SLIC according to the inventive principles set forth herein above.

What is claimed is:

1. A subscriber loop interface circuit comprising:
an AC current source configured to synthesize a desired impedance termination and further to implement high fidelity speech transmit and receiving functions; and
a constant DC current source in parallel with the AC current source and configured to have an efficiency of at least 80% and further to present a high impedance to voice band signals.

2. The subscriber loop interface circuit according to claim 1 wherein the DC current source comprises a switched-mode current boost converter.

3. The subscriber loop interface circuit according to claim 2 wherein the switched-mode current boost converter comprises a first semiconductor switch and a second semiconductor switch, wherein the first and second semiconductor switches are configured such that when the first semiconductor switch is open, the second semiconductor switch is closed to implement a first state, and further such that when the first semiconductor switch is closed, the second semiconductor switch is open to implement a second state.

4. The subscriber loop interface circuit according to claim 3 wherein the switched-mode current boost converter further comprises a capacitor configured to be charged by a current source when the first and second semiconductor switches are in the first state, and further configured to be discharging when the first and second semiconductor switches are in the second state.

5. The subscriber loop interface circuit according to claim 4 wherein the switched-mode current boost converter further comprises a series inductor at its output, wherein the inductor is operational to achieve the high impedance in a subscriber line voice band, and further wherein the inductor has an inductance that is sufficient to limit converter output current ripple to less than about one percent.

6. The subscriber loop interface circuit according to claim 5 wherein the first semiconductor switch comprises a CMOS transistor that is operational in response to a dynamically time varied input signal to cause the switched-mode current boost converter to switch between its first and second states to maintain a constant output current.

7. The subscriber loop interface circuit according to claim 6 wherein the second semiconductor switch comprises a fast response diode that is operational to switch alternately and in complimentary fashion with the CMOS transistor in response to the dynamically time varied input signal.

8. The subscriber loop interface circuit according to claim 1 wherein the DC current source comprises a switched-mode voltage-to-current trans-converter.

9. The subscriber loop interface circuit according to claim 8 wherein the switched-mode voltage-to-current trans-converter comprises a first semiconductor switch and a second semiconductor switch, wherein the first and second semiconductor switches are configured such that when the first semiconductor switch is open, the second semiconductor switch is closed to implement a first state, and further such that when the first semiconductor switch is closed, the second semiconductor switch is open to implement a second state.

10. The subscriber loop interface circuit according to claim 9 wherein the switched-mode voltage-to-current trans-converter converter further comprises a series inductor at its output, wherein the inductor is operational to achieve the high impedance in a subscriber line voice band, and further wherein the inductor has an inductance that is sufficient to limit trans-converter output current ripple to no more than about one percent.

11. The subscriber loop interface circuit according to claim 10 wherein the first semiconductor switch comprises a CMOS transistor that is operational in response to a dynamically time varied input signal to cause the switched-mode voltage-to-current trans-converter to switch between its first and second states to maintain a constant output current.

12. The subscriber loop interface circuit according to claim 11 wherein the second semiconductor switch comprises a fast response diode that is operational to switch alternately and in complimentary fashion with the CMOS transistor in response to the dynamically time varied input signal.

13. A subscriber loop interface circuit comprising:
a switched-mode current boost converter configured to provide a constant DC current feed to a subscriber line, wherein the current boost converter includes:
at least one capacitor;
at least one output series inductor;
a first switch; and
a second switch, wherein the first and second switches are responsive to a dynamically time varied input signal to switch alternately and in complementary fashion to implement a first state and a second state such that the at least one capacitor is caused to be charged by a current source while in the first state and to be discharging via the at least one output series inductor while in the second state to generate the constant DC current feed.

14. The subscriber loop interface circuit according to claim 13 further comprising an AC current source configured to synthesize a subscriber line termination impedance and to implement subscriber line high fidelity speech transmit and receiving functions.

15. The subscriber loop interface circuit according to claim 13 wherein the first switch comprises a CMOS transistor that is operational in response to the dynamically time varied input signal to cause the switched-mode current boost converter to switch between its first and second states to maintain a constant DC output current.

16. The subscriber loop interface circuit according to claim 15 wherein the second switch comprises a fast response diode that is operational to switch alternately and in complimentary fashion with the CMOS transistor in response to the dynamically time varied input signal.

17. The subscriber loop interface circuit according to claim 13 wherein the dynamically time varied input signal is generated via a pulse width modulated controller.

18. A subscriber loop interface circuit comprising:
a switched-mode voltage-to-current trans-converter configured to provide a constant DC current feed to a subscriber line, wherein the voltge-to-current trans-converter includes:
at least one output series inductor;
a first switch; and
a second switch, wherein the first and second switches are responsive to a dynamically time varied input signal to switch alternately and in complementary fashion to implement a first state and a second state such that the at least one output series inductor is caused to be charged by a voltage source while in the first state and to be discharging via the subscriber line while in the second state to generate the constant DC current feed.

19. The subscriber loop interface circuit according to claim 18 further comprising an AC current source configured to synthesize a subscriber line termination impedance and to implement subscriber line high fidelity speech transmit and receiving functions.

20. The subscriber loop interface circuit according to claim 18 wherein the first switch comprises a CMOS transistor that is operational in response to the dynamically time varied input signal to cause the switched-mode voltage-to-current trans-converter to switch between its first and second states to maintain a constant DC output current.

21. The subscriber loop interface circuit according to claim 20 wherein the second switch comprises a fast response diode that is operational to switch alternately and in complimentary fashion with the CMOS transistor in response to the dynamically time varied input signal.

22. The subscriber loop interface circuit according to claim 18 wherein the dynamically time varied input signal is generated via a pulse width modulated controller.

23. A method of generating a subscriber line constant DC current feed comprising the steps of:
(a) providing a switched-mode current boost converter having a charging/discharging capacitor and further having a series output inductor coupled to the subscriber line;
(b) charging the capacitor via a current source for a first time period in response to a dynamically time variable input signal; and
(c) discharging the capacitor via the series output inductor for a second time period in response to the dynamically time variable input signal such that there is neither a net increase nor a net decrease of energy in the inductor and the capacitor, and further to generate a constant DC output current to the subscriber line, wherein the DC output current has a magnitude that is greater than the source current that is operative to charge the capacitor.

24. A method of generating a subscriber line constant DC current feed comprising the steps of:
(a) providing a switched-mode voltage-to-current trans-converter having a series output inductor coupled to the subscriber line;
(b) charging the inductor via a voltage source for a first time period in response to a dynamically time variable input signal; and
(c) discharging the inductor via the subscriber line for a second time period in response to the dynamically time variable input signal such that there is neither a net increase nor a net decrease of energy in the inductor, and further to generate a constant DC output current to the subscriber line such that the DC output current has a magnitude that remains constant with changing subscriber line impedance.

25. A subscriber loop interface circuit comprising:
means for synthesizing a subscriber line termination impedance and further for implementing high fidelity speech transmit and receiving functions; and
means for generating a subscriber line constant DC current and for presenting a high impedance to subscriber line voice band signals, wherein the generating means has an efficiency of at least 80%.
